(19) United States
(12) Patent Application Publication
(10) Pub. No.: US 2002/0097146 A1
(43) Pub. Date: Jul. 25, 2002

(54) School bus driver's vision enhancement system

(76) Inventor: Troy Whitfield Harris III, Thomasville, NC (US)

Correspondence Address: RHODES & MASON, P.L.L.C., P.O. BOX 2974, GREENSBORO, NC, 27402, US

(21) Appl. No.: 09/769,158

(22) Filed: Jan. 24, 2001

(51) Int. Cl. B60Q 1/00

(52) U.S. Cl. 340/435; 340/901; 340/433

(57) ABSTRACT

A school bus driver's vision enhancement system for detecting children in dangerous zones around the bus and alerting the bus driver when such children have been detected. Sensors are mounted along the roofline of the bus, preferably on the mirror housings, and are pointed towards the road surface to provide a broader coverage area on the road surface than known school bus sensor systems. A lighted display unit is provided within view of the bus driver to alert the driver when the sensors have detected an obstacle, such as a child. The lighted display units include lights that are energized when any one of the sensors detects an obstacle. The bus may be configured to automatically actuate the brakes or other means to prevent movement of the bus if the motor is turned on, the bus is in a stopped position, and an object is detected by one the sensors.

### BACKGROUND OF THE INVENTION

The present invention relates generally to school bus safety and, more particularly to a system for detecting children in the areas surrounding a school bus and alerting the bus driver when such children have been detected.

School buses are one of the safest forms of transportation that exists. In fact, school buses are about thirty times safer than passenger cars. The greatest potential for danger involving school buses is actually not riding the bus. Rather, it is those moments right before a passenger gets on the bus and right after a passenger gets off the bus. Particularly, all school buses are surrounded by a ten foot area known as the danger zone. In this area, it is especially difficult for the bus driver to see obstacles, such as small children. Areas in front of the bus chassis are dangerous because the bus driver typically sits up too high to see the obstacles located directly in front of the bus. Similarly, obstacles that are too close to the sides of the bus may be in the driver's blind spot. Further, the bus driver is unable to see obstacles located behind the bus.

Various systems have and proposed to alert a bus driver of obstacles, such as children, in these danger zones. For example, most buses include multiple side-view and crossover mirrors that enhance the bus driver's viewing areas. Some buses also include crossing control arms that are six foot gates attached to the front bumper of the bus to keep children far enough in front of the bus for them to be seen by the driver while they cross the street.

Other known systems include sensors and radars that are mounted under the bus to detect obstacles under the bus and alongside the bus. These sensors, however, do not provide a wide coverage area because they are mounted so low to the road surface.

Thus, there remains a need for a system that provides bus drivers with an enhanced viewing area and detects obstacles in an enhanced coverage area around the bus chassis.

### SUMMARY OF THE INVENTION

The present invention fulfills this need in the art by providing a school bus including a bus chassis adapted for riding on a roadway and a body riding on the chassis, the body having an outside and including a door into which an adult can walk without stooping and a roofline above the door, a rear view mirror on the outside of the body at an elevation proximate the roofline of the body, and at least one directional sensor mounted on the mirror at an elevation proximate the roofline and emitting sensing radiation downwardly toward the roadway. The area of coverage subtended by the roadway is substantially larger than an area of coverage by a similar sensor mounted on the bus chassis. Preferably, the directional sensor is a Doppler radar, infrared detector, radio wave signal detector, electromagnetic sensor, ultrasound sensor, sonar, or field disturbance sensor.

The school bus may further include a lighted display unit that alerts a driver of the school bus when an object is detected by the directional sensor. The lighted display unit may be positioned on a right side view mirror, a left side view mirror, a switch panel located within the body of the bus and within the bus driver's view, and/or a dashboard within the body of the bus and within the bus driver's view. In one embodiment, the lighted display unit includes at least one light source that may be a light emitting diode or an incandescent lamp that is energized upon detection of an object by the directional sensor. In another embodiment, the lighted display unit includes a plurality of lights such that each light in the lighted display unit corresponds with at least one directional sensor. In an additional embodiment, the lighted display unit further includes a physical representation of the bus such that each light corresponds to a location of at least one directional sensor on the bus.

Preferably, the school bus also includes means for automatically preventing movement of the bus when an object is detected by the directional sensor. This may be done by controlling a mechanism such as the brakes, the parking brake, the service brake, the accelerator, the transmission, the drive line, the throttle, or the engine fuel pump.

The present invention further provides a method for enhancing a school bus driver's awareness of people in proximity to the school bus including the steps of driving a school bus on a roadway. The school bus has a bus chassis and a body having an outside and including a door into which an adult can walk without stooping and a roofline above the door. The method includes stopping the bus to let passengers enter the body of the bus or exit the body of the bus, viewing a rearview mirror that is located on the outside of the body of the bus at an elevation proximate to the roofline of the body, and sensing whether a person is in proximity to the bus with at least one directional sensor that is located on the mirror at an elevation proximate to the roofline and is configured to emit sensing radiation downwardly toward the roadway such that an area of coverage subtended by the roadway is substantially larger than an area of coverage by a similar sensor mounted on the bus chassis.

The present invention also provides a kit for retrofitting a school bus to provide enhanced driver awareness of people in proximity to the school bus including a directional sensor, the directional sensor being configured to emit sensing radiation downwardly toward a roadway, and a mounting apparatus to mount the directional sensor proximate a roofline of a school bus, whereby the sensor can be mounted high on the bus so that an area of sensor coverage subtended by the roadway is substantially larger than an area of coverage by a similar sensor apparatus mounted on a chassis of the bus.

In addition, the present invention provides a method of operating a school bus including the steps of installing directional sensors high on the bus and pointing the directional sensors downwardly, driving the bus to bus stops to pick up and discharge passengers, while stopped at a bus stop, actuating the directional sensors that are high on the bus to cover a wide area of roadway around the bus and detect passengers who may be in danger if the bus proceeds while the passengers remain where they are, and displaying to a bus driver indication of the detected presence of passengers in danger.

### BRIEF DESCRIPTION OF THE DRAWINGS

The invention will be better understood by a reading of the Detailed Description of the Preferred Embodiments along with a review of the drawings, in which:

FIG. 1 is a partial perspective view of an embodiment of a school bus having sensor assemblies in accordance with the present invention.

FIG. 2 is a perspective view of one of the mirror housings and sensor assemblies of FIG. 1.

FIG. 3 is a schematic diagram of a comparison of the scope of coverage with a bus having a prior art sensor assembly and the sensor assembly of the present invention.

FIG. 4 is a perspective view of one embodiment of the lighted display assemblies that are viewable from the bus driver's seat.

FIG. 5 is a perspective view of an optional alternate lighted display assembly that may be viewable from the bus driver's seat.

### DETAILED DESCRIPTION OF THE PREFERRED EMBODIMENT

In the following description, like reference characters designate like or corresponding parts throughout the several views. It will be understood that the illustrations are for the purpose of describing a preferred embodiment of the invention and are not intended to limit the invention thereto.

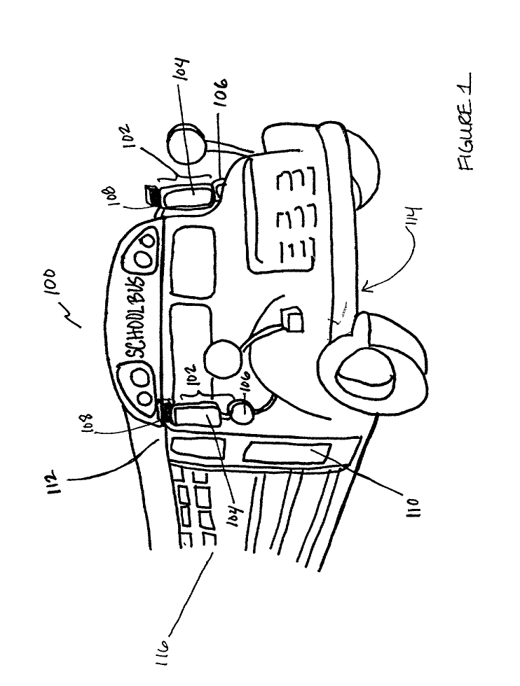

As best seen in FIG. 1, a school bus having a vision enhancement system is shown in accordance with the present invention. The school bus 100 includes a chassis 114 for riding on a roadway and a body 116 that rides on the chassis 114. The body 116 houses a bus driver's seat and a plurality of passenger seats. The body 116 also includes a door 110 that provides means for ingress to and egress from the inside of the body 116 of the bus 100. The door 110 is tall enough to allow an adult to pass through the doorway without stooping.

The bus 100 further includes external rearview mirror assemblies 102 mounted high on both the right and left sides of the bus 100. Such mirror assemblies 102 are known in the art and may include both an elongated mirror 104 and a smaller circular mirror 106. Generally, such mirror assemblies 102 are mounted to the bus 100 such that the top of the highest mirror is aligned with the roofline 112 of the bus, allowing the bus driver to effectively use the mirrors 104, 106 from the bus driver's seat.

Directional sensors 108 are preferably mounted on top of the mirror assemblies 102 such that the sensors 108 are also disposed along the roofline 112 of the bus, as shown in FIG. 2. The sensors 108 are pointed downwardly, towards the road surface, so that they may detect children within the danger zones around the bus 100. It should be understood that any number of sensors 108 may be disposed along the roofline 112 of the bus, and the invention is not limited to having only one mounted on each side. The directional sensors 108 may be of any type known in the art such as Doppler radars, infrared detectors, radio wave signal sensors, electromagnetic sensors, and ultrasound sensors. In preferred embodiments, the sensors are sonar or field disturbance sensors. A feature of the selected sensors is that the signals emanate from and/or return to the sensors along a trajectory at an angle having an apex at the sensor. Typically, the trajectory is the volume in a cone, but pyramidal or oval or elliptical sectioned shapes may also be contemplated as well as other shapes arising from the divergence of the sensor beam from the sensor. Detectors with configured lobes are also contemplated.

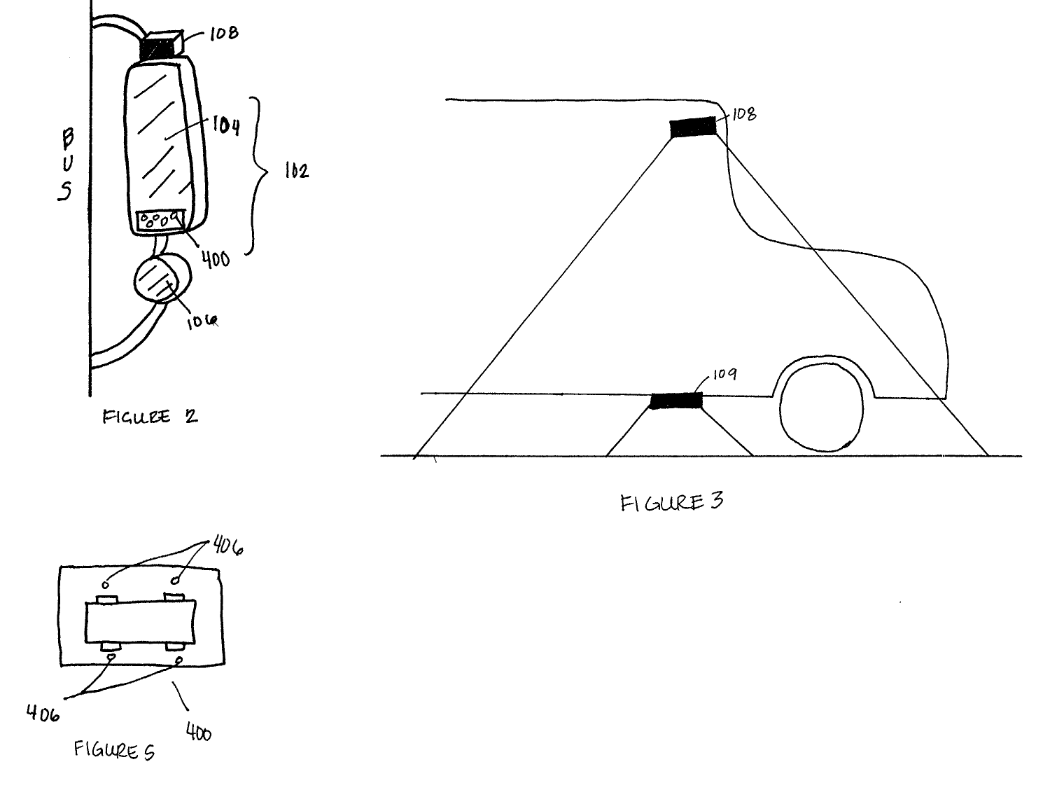

As shown in FIG. 3, when the sensor 108 is mounted on the bus 100 and pointed towards the road surface, an area of coverage is projected downwardly from the sensor 108 increasing in area as the distance from the sensor 108 increases. The greater the distance is between the sensor 108 and the road surface, the larger the coverage area is on the road surface as indicated by comparison of the subtended angle from sensor 108. This area is, as apparent, much larger than the area of coverage by the sensor 109, which is mounted as has been done in the prior art. Thus, mounting the sensors 108 high on the bus such as along the roofline 112 of the bus 100 provides significant advantages over prior art sensor assemblies that are mounted near the bottom of the bus, because the road surface area subtending the sensor beam is larger, providing more coverage.

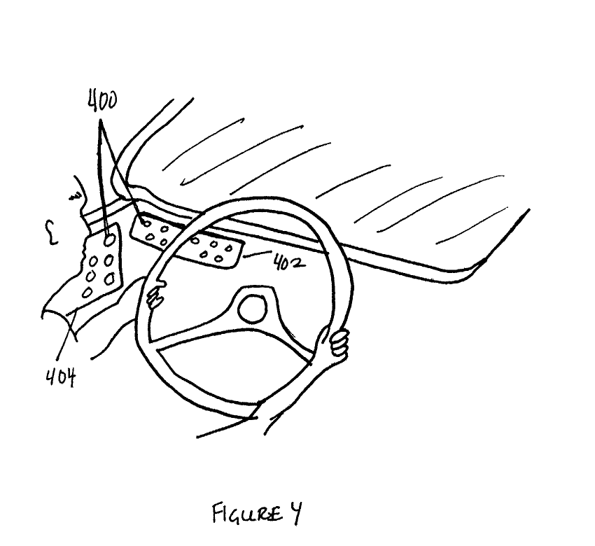

As shown in FIG. 4, a lighted display unit 400 may be provided on either the dashboard 402 of the bus or in the in the switch panel 404 of the bus to alert the bus driver when an object, such as a child, is detected by a sensor 108 on either side of the bus. As shown in FIG. 2, the lighted display unit 400 may also be provided on the exterior mirror assemblies 102. Any suitable mounting location may be substituted.

The lighted display units 400 may include any type of light source such as a light emitting diode (LED) or an incandescent lamp that is energized when an object is detected by one of the directional sensors 108. Other signaling forms may be substituted, including audible signals. In a preferred embodiment, the lighted display unit 400 includes an outline of a bus chassis that is surrounded by LEDs or incandescent lamps 406 corresponding with the number and location of sensors 108 mounted on the bus 100, as shown in FIG. 5. The LEDs or lamps 406 indicate which sensor has detected an object and where that sensor is located on the bus 100. In an alternative embodiment, the LED's or incandescent lamps 406 may correspond with an array of sensors 108 on the bus to indicate when an obstacle has been detected in a given zone. When the bus driver is preparing to depart from a bus stop, the driver may easily glance at one of the lighted display units 400 to determine whether the danger zones are clear, in addition to using conventional measures. If a child is detected, the bus driver may take such as action as necessary to remove the child from the areas surrounding the bus by, for example, blowing the horn or physically leaving the bus to wam the child.

In another embodiment of the present invention, the bus may be configured to prevent movement of the bus if a child is detected in the danger zones. For example, if the motor of the bus is turned on, the bus is stopped, and an object is detected by one of the directional sensors 108, the control system of the bus may be configured to automatically actuate the brakes of the bus until the object in the view of the sensors has been cleared. Alternatively, the control system may be configured to lock out the throttle of the bus, actuate the service brake or parking brake, deactivate the accelerator, disengage the transmission, engine fuel pump, or drive line, or otherwise inhibit the bus' progress.

As will be apparent, the present invention provides an effective way for a bus driver to determine whether a child is located in the danger zone surrounding the bus chassis, before departing from a bus stop. The directional sensors provide a broad area of coverage surrounding the bus with minimal investment in sensors, sensor wiring and maintenance. The lighted display units effectively notify the bus driver when a child is detected.

Certain modifications and improvements will occur to those skilled in the art upon reading the foregoing description. It should be understood that all such modifications and improvements have been omitted for the sake of conciseness and readability, but are properly within the scope of the following claims.

For example, the sensor may be installed as after market equipment by the installation of a retrofit kit. Such kit may include the sensor, a mounting bracket for the sensor to permit the mounting in locations as described above, and a signaling unit as described above, along with associated wiring.

What is claimed is:

1. A school bus providing enhanced driver awareness of people in proximity to the bus comprising:
a bus chassis adapted for riding on a roadway and a body riding on the chassis, the body having an outside and including a door into which an adult can walk without stooping and a roofline above the door;
a rear view mirror on the outside of the body at an elevation proximate the roofline of the body; and
at least one directional sensor mounted on the mirror at an elevation proximate the roofline and emitting sensing radiation downwardly toward the roadway, wherein an area of coverage subtended by the roadway is substantially larger than an area of coverage by a similar sensor mounted on the bus chassis.

2. The school bus of claim 1 wherein the directional sensor is selected from the group consisting of Doppler radar, infrared detector, radio wave signal detector, electromagnetic sensor, ultrasound sensor, sonar, and field disturbance sensor.

3. The school bus of claim 1 further comprising at least one lighted display unit that alerts a driver of the school bus when an object is detected by the directional sensor.

4. The school bus of claim 3 wherein the lighted display unit is positioned on at least one of a right side view mirror and a left side view mirror.

5. The school bus of claim 3 wherein the lighted display unit is positioned on a switch panel located within the body of the bus and within view of the driver of the bus.

6. The school bus of claim 3 wherein the lighted display unit is positioned on a dashboard within the body of the bus and within view of the driver of the bus.

7. The school bus of claim 3 wherein the lighted display unit includes at least one light source that is energized upon detection of an object by the directional sensor.

8. The school bus of claim 7 wherein the light source is selected from the group consisting of a light emitting diode and an incandescent lamp.

9. The school bus of claim 3 wherein the lighted display unit includes a plurality of lights and each light in the lighted display unit corresponds with at least one directional sensor.

10. The school bus of claim 9 wherein the lighted display unit further includes a physical representation of the bus such that each light corresponds to a location of at least one directional sensor on the bus.

11. The school bus of claim 1 further comprising means for automatically preventing movement of the bus when an object is detected by the directional sensor.

12. The school bus of claim 11 wherein movement of the bus is automatically prevented by control of a mechanism selected from the group consisting of a brake, a service brake, a parking brake, an accelerator, a transmission, a drive line, a throttle, and an engine fuel pump.

13. A school bus providing enhanced driver awareness of children in proximity to the bus comprising:
a bus chassis adapted for riding on a roadway and a body riding on the chassis, the body having an outside and including a door into which an adult can walk without stooping and a roofline above the door; and
at least one directional sensor mounted at an elevation proximate the roofline and emitting sensing radiation downwardly toward the roadway, wherein an area of coverage subtended by the roadway is substantially larger than an area of coverage by a similar sensor mounted on the bus chassis.

14. A method for enhancing a school bus driver's awareness of people in proximity to the school bus comprising the steps of:
driving a school bus on a roadway, the school bus comprising a bus chassis and a body having an outside and including a door into which an adult can walk without stooping and a roofline above the door;
stopping the bus to let passengers enter the body of the bus or exit the body of the bus;
viewing a rearview mirror that is located on the outside of the body of the bus at an elevation proximate to the roofline of the body; and
sensing whether a person is in proximity to the bus with at least one directional sensor that is located on the mirror at an elevation proximate to the roofline and is configured to emit sensing radiation downwardly toward the roadway such that an area of coverage subtended by the roadway is substantially larger than an area of coverage by a similar sensor mounted on the bus chassis.

15. The method of claim 14 further comprising the step of selecting the directional sensor from the group consisting of Doppler radar, infrared detector, radio wave signal detector, electromagnetic sensor, ultrasound sensor, sonar, and field disturbance sensor.

16. The method of claim 14 further comprising the step of alerting a driver of the school bus when an object is detected by the directional sensor with a lighted display unit.

17. The method of claim 16 further comprising the step of viewing the lighted display unit on at least one of a right side-view mirror and a left side-view mirror.

18. The method of claim 16 further comprising the step of viewing the lighted display unit on a switch panel located within the body of the bus.

19. The method of claim 16 further comprising the step of viewing the lighted display unit on a dashboard within the body of the bus.

20. The method of claim 16 further comprising the step of energizing at least one light source in the lighted display unit upon detection of an object by the directional sensor.

21. The method of claim 20 further comprising the step of selecting the light source from the group consisting of a light emitting diode and an incandescent lamp.

22. The method of claim 16 further comprising the step of correlating each light of a plurality of lights in the lighted display unit with at least one directional sensor.

23. The method of claim 23 further comprising the step of correlating each light with a location of at least one directional sensor on the bus on a physical representation of the bus in the lighted display unit.

24. The method of claim 14 further comprising the step of automatically preventing movement of the bus when an object is detected by the directional sensor.

25. The method of claim 24 wherein the preventing movement step comprises the step of controlling a mechanism on the bus selected from the group consisting of a brake, a service brake, a parking brake, an accelerator, a transmission, a drive line, a throttle, and an engine fuel pump.

26. A method for enhancing a school bus driver's awareness of people in proximity to the school bus comprising the steps of:
driving a school bus on a roadway, the school bus comprising a bus chassis and a body having an outside and including a door into which an adult can walk without stooping and a roofline above the door;
stopping the bus to let passengers enter the body of the bus or exit the body of the bus; and
sensing whether a person is in proximity to the bus with at least one directional sensor that is located at an elevation proximate to the roofline and is configured to emit sensing radiation downwardly toward the roadway such that an area of coverage subtended by the roadway is substantially larger than an area of coverage by a similar sensor mounted on the bus chassis.

27. A kit for retrofitting a school bus to provide enhanced driver awareness of people in proximity to the school bus comprising:
a directional sensor, the directional sensor being configured to emit sensing radiation downwardly toward a roadway; and
a mounting apparatus to mount the directional sensor proximate a roofline of a school bus;
whereby the sensor can be mounted high on the bus so that an area of sensor coverage subtended by the roadway is substantially larger than an area of coverage by a similar sensor apparatus mounted on a chassis of the bus.

28. The retrofit kit of claim 27 wherein the directional sensor is selected from the group consisting of a Doppler radar, infrared detector, radio wave signal detector, electromagnetic sensor, ultrasound sensor, sonar, and field disturbance sensor.

29. The retrofit kit of claim 27 further comprising a lighted display unit that is configured to alert a driver of the school bus when an object is detected by the directional sensor.

30. The retrofit kit of claim 29 wherein the lighted display unit is configured for installation on a switch panel located within a body of the bus and within view of the driver of the bus.

31. The retrofit kit of claim 29 wherein the lighted display unit is configured for installation on a dashboard located within a body of the bus and within view of the driver of the bus.

32. The retrofit kit of claim 29 wherein the lighted display unit includes at least one light source that is energized upon detection of an object by the directional sensor.

33. The retrofit kit of claim 32 wherein the light source is selected from the group consisting of a light emitting diode and an incandescent lamp.

34. The retrofit kit of claim 29 wherein the lighted display unit includes a plurality of lights and each light corresponds with at least one directional sensor.

35. The retrofit kit of claim 34 wherein the lighted display unit further includes a physical representation of the bus such that each light corresponds to a location of at least one directional sensor on the bus.

36. The retrofit kit of claim 29 further comprising at least one of a left side view mirror and a right side view mirror that includes the lighted display unit.

37. The retrofit kit of claim 27 wherein the mounting apparatus is a side view mirror.

38. The retrofit kit of claim 27 wherein the mounting apparatus is a bracket to mount the sensor on a side view mirror.

39. A method of operating a school bus comprising the steps of:
installing directional sensors high on the bus and pointing the directional sensors downwardly;
driving the bus to bus stops to pick up and discharge passengers;
while stopped at a bus stop, actuating the directional sensors that are high on the bus to cover a wide area of roadway around the bus and detecting passengers who may be in danger if the bus proceeds while the passengers remain where they are; and
displaying to a bus driver indication of the detected presence of passengers in danger.
